(19) United States
(12) Patent Application Publication
(10) Pub. No.: US 2011/0280017 A1
(43) Pub. Date: Nov. 17, 2011

(54) Optical system for shaping a laser beam, and laser system having such an optical system

(76) Inventor: Lieu-Kim Dang, Gams (CH)

(21) Appl. No.: 13/104,680

(22) Filed: May 10, 2011

(30) Foreign Application Priority Data
May 10, 2010 (DE) 102010028794.6

(51) Int. Cl. G02B 27/09

(52) U.S. Cl. 362/259; 359/838

(57) ABSTRACT

An optical system is provided for shaping a laser beam, having a first optical element which is designed at least partially as a base body, the base body having a base surface area and having a curved surface area which abuts said base surface area. The base surface area and the curved surface area are designed at least partially as transmission surfaces for the laser beam, and the base body has a recess with a curved surface area, wherein the curved surface area is designed at least partially as a reflecting surface for the laser beam.

### RELATED APPLICATIONS

The present application claims priority to German Patent Application DE 102010028794.6, filed May 10, 2010, entitled “Optical System for Shaping a Laser Beam, and Laser System Having Such an Optical System,” the entire content of which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to an optical system for shaping the beam of a laser, as well as a laser system having such an optical system.

U.S. Pat. No. 7,497,018 B2 discloses a laser system wherein a round laser beam in the shape of a spot is converted into a flat laser beam with a linear shape by means of a system of optics. The laser system has a housing and a beam device arranged in said housing, wherein said beam device consists of a laser beam source for the generation of a laser beam as well as the system of optics. The system of optics has a first optical element, and a second optical element which is designed as a collimating lens. Both of these are arranged in an optical system support.

The laser beam source generates a primary divergent laser beam. The primary divergent laser beam is directed at the collimating lens, which collimates the primary laser beam and generates a parallel secondary laser beam. The secondary laser beam is directed to the first optical element, which is arranged downstream from the collimating lens with respect to the direction of propagation, and which is designed as a conical mirror. A conical minor is a reflective optical element which is at least partially designed in the shape of a cone having a base surface area and a curved surface area which abuts said base surface area. The curved surface area of the conical minor is designed as a reflective surface which converts the secondary laser beam to a flat laser beam with a linear shape and reflects the same at an angle of 90°.

One problem with this known system, which has multiple optical elements, is that the optical elements must be aligned with respect to one another, and must be fixed in an aligned arrangement. In the case of various materials, including for example glass and metal, variations in temperature result in the materials distorting to differing degrees, thereby resulting in alignment errors which reduce the precision of the system. Laser systems are frequently subjected to inclement environmental conditions during use, and must be able to withstand extreme thermal stress from the environment.

In light of this issue, the problem addressed by the present invention is that of developing an optical system and a laser system having such an optical system, wherein the complexity and demands of alignment, as well as errors in alignment, are reduced.

### BRIEF SUMMARY OF THE INVENTION

According to embodiments of the present invention, this problem is solved by the features of the independent claim of the optical system described below. Further advantageous embodiments are given in the dependent claims.

Certain embodiments of the present invention provide an optical system for the shaping of a laser beam, having a first optical element which is at least partially designed as a base body with a base surface area and with a curved surface area abutting the base surface area.

According to certain embodiments of the present invention, the base surface area and curved surface area of the base body are at least partially designed as transmission surfaces for the laser beam, and the base body has a recess with a curved surface area which is at least partially designed as a reflective surface for the laser beam. An incident laser beam is fundamentally divided into three parts at an interface between a first and a second optical medium: a first part thereof is reflected at the interface (the reflected laser beam), a second part passes through the interface into the second optical medium (the transmitted laser beam), and a third part is absorbed at the interface (absorbed laser beam). The respective fractions of the reflected, the transmitted, and the absorbed laser beams can be modified by, for example, the wavelength and/or the angle of incidence of the arriving laser beam, and/or by a coating on the interface. An interface is characterized as a transmission surface when a laser beam is transmitted from a first into a second optical medium at the interface. An interface is characterized as a reflective surface when a laser beam is reflected inside an optical medium at the interface. A design wherein the base body has two transmission surfaces offers the advantage that additional functions are integrated into the base body, or can be included in the direct proximity of the base body.

One preferred embodiment includes a second optical element which is integrated into the first optical element, wherein the second optical element is preferably integrated into the base surface area of the base body, into the curved surface area of the recess, or into the curved surface area of the base body. In this case, the term “integrated” means that no interface exists between the first and the second optical elements. The term “interface” is defined as an area arranged between two media which have different refractive indices. This embodiment has the advantage that only one optical system support is required, and the alignment of both optical elements is carried out during the manufacturing process.

In an alternative preferred embodiment, a second optical element is provided which directly abuts the first optical element, and the second optical element most preferably directly abuts the base surface area of the base body, the curved surface area of the recess, or the curved surface area of the base body. In this case, the term “directly abuts” means that the first and the second optical elements have a common interface, and no optical element or other medium with a different refractive index, such as air for example, is arranged between the optical surface area of the second optical element and the optical surface area of the first optical element. This embodiment has the advantage that two different materials can be combined, with the result that the properties of the optical system are more flexible, and it is possible to adjust said properties to particular given requirements. Moreover, only one optical system support is required, and the alignment of both optical elements can be carried out during the manufacturing of the optical system rather than at a later point.

In a preferred embodiment, the recess has a top surface area which abuts the curved surface area, said top surface area being at least partially designed as a transmission surface for the laser beam. Most preferably, an optical element is provided which is integrated into the top surface area or directly abuts the top surface area of the recess. This embodiment has the advantage that a round beam with a spot shape can be generated in addition to a flat beam with a linear shape. The beam shape of the round beam can be adjusted via the optical element which is integrated into, or directly abuts, the top surface area. A collimated or focused round beam can be generated by means of an optical collimating or focusing system.

In addition, certain embodiments of the present invention relate to a laser system having a beam source to generate a laser beam, as well as an optical system.

An adjustment device is preferably provided, by means of which the position of the beam source with respect to the optical system and/or the position of the optical system with respect to the beam source can be adjusted in the longitudinal direction of the propagation of the beam, and/or in a plane which is perpendicular to the longitudinal direction of the propagation of the beam.

In a preferred embodiment of the laser system, a first optical system which generates a first flat laser beam, and a second optical system which generates a second flat laser beam, are provided. Most preferably, a third optical system, which generates a third flat laser beam, is provided. In this case, the flat laser beams are arranged perpendicular to each other or with a defined angle to each other.

In a further preferred embodiment of the laser system, at least one optical system is designed in such a manner that a round laser beam can be generated in addition to a flat laser beam.

Additional advantages and advantageous embodiments of the subject of the invention are demonstrated in the description, in the drawings, and in the claims. Likewise, the features named above as well as those further explained below can be incorporated according to embodiments of the present invention either alone or in any number of combinations. The embodiments illustrated and described here should not be understood as an exhaustive and exclusive listing, but rather offer particular examples for the purpose of explaining the invention.

### BRIEF DESCRIPTION OF SEVERAL VIEWS OF THE DRAWINGS

FIG. 1 shows a laser system having a first embodiment of an optical system according to an embodiment of the present invention, said optical system being designed as a circular cylinder with a conical recess, and having an optical collimating lens which is integrated into the base surface area of the circular cylinder.

FIG. 2 shows a second embodiment of an optical system according to an embodiment of the present invention, wherein said optical system is designed as a truncated cone with a recess having the shape of a truncated cone, and having an optical collimating lens which is integrated into the curved surface area of the truncated conical recess.

FIG. 3 shows a third embodiment of an optical system according to an embodiment of the present invention, wherein said optical system is designed as a circular cylinder having a conical recess, and having an optical focusing device which directly abuts the curved surface area.

FIG. 4 shows a laser system having a first, second, and third optical system according to an embodiment of the present invention, which produce three flat laser beams with a linear shape which are arranged perpendicular to each other, as well as one round laser beam with a spot shape.

### DETAILED DESCRIPTION OF THE INVENTION

Identical elements or elements which perform the same function are indicated by the same reference numbers in the figures, unless otherwise noted.

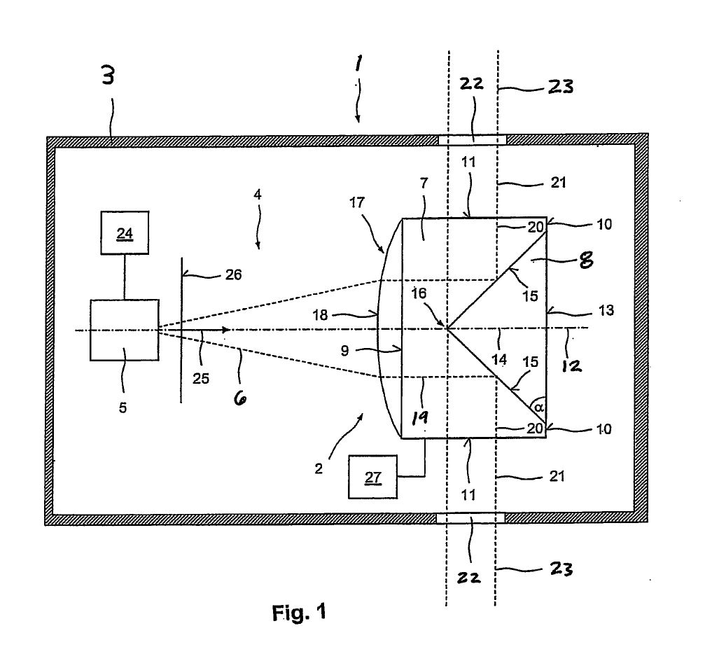

FIG. 1 shows a laser system 1 having an optical system 2 according to an embodiment of the present invention, said optical system being designed as an optical beam-shaping device. The laser system 1 has a housing 3 and a beam device 4 arranged in the housing 3, wherein said beam device 4 consists of a beam source 5 and the optical beam-shaping device 2 according to an embodiment of the present invention.

The beam source 5 in the illustrated embodiment is designed as a semiconductor laser which generates a primary laser beam 6 in the visible spectrum, for example a red laser beam with a wavelength of 635 nm or a green laser beam with a wavelength of 532 nm. Following the initial propagation of the primary laser beam 6 out of the beam source 5, the inherent divergence of the beam results in an expansion of the size of the beam 6, meaning that the radius of the primary laser beam 6 increases in proportion to the distance at which the laser beam 6 is observed from the beam source 5. By utilizing an optical collimating lens, a laser beam can be collimated.

The optical beam-shaping device 2 according to an embodiment of the present invention is arranged behind the beam source 5 in the path of the beam. The optical beam-shaping device 2 in the illustrated embodiment is designed as a base body having the shape of a right circular cylinder 7 with a recess 8. A circular cylinder is a cylinder with a circular base surface area. A cylinder is bounded by two parallel, flat surfaces which are termed the base surface area and the top surface area, and by a curved surface area. A cylinder is formed by the displacement of a bounded surface area lying in a plane along a straight line which does not lie in the plane and which defines the cylinder axis. A right cylinder has a cylinder axis which extends perpendicular to the base surface area, whereas a tilted cylinder axis is arranged at an angle not equal to 90° from the base surface area. The distance between the two planes in which the base and top surface areas lie defines the height of the cylinder.

The surface of the circular cylinder 7 has a circular base surface area 9, a circular top surface area 10 parallel to said base surface area 9, and a curved surface area 11 which connects the base surface area 9 and the top surface area 10. The base and top surface areas 9, 10 are arranged perpendicular to the cylinder axis 12, and the curved surface area 11 is arranged parallel thereto. The base surface area 9 and the curved surface area 11 of the circular cylinder 7 each form an interface lying between the optical beam-shaping device 2 and the surrounding environment, and are termed transmission surfaces for the laser beam in the following description.

The transmittance of a transmission surface depends on the angle of incidence of a laser beam arriving at the surface, and on the refractive index of the materials, among other things. The transmittance can be increased by coating the same. The intensity of the laser beam, and therefore the visibility of the beam at the target object, is higher when the fraction of the laser beam transmitted through the transmission surface is higher.

The optical beam-shaping device 2 has a recess 8 which is designed in the illustrated embodiment as a right circular cone. A circular cone is a cone with a circular base surface area. A cone is a geometric object which is formed when all the points of a bounded surface area lying in a plane are connected by straight lines to a point which lies outside the plane. The surface area is termed the base surface area, the boundary line of the base surface area is termed the template contour, and the point is termed the cone tip. The distance between the cone tip and the base surface area defines the height of the cone. The lines connecting the template contour to the cone tip are termed the curved surface lines, and the sum of all lines connecting the cone tip to the template contour is termed the curved surface area of the cone. In the case of a right cone with a circular base surface area, the cone tip lies in the cone axis, which itself extends perpendicular to the base surface area through the center point of the base surface area. In contrast, in the case of a tilted circular cone, the cone axis extends from a point outside the center point of the base surface area.

The surface of the circular recess 8 comprises a circular base surface area 13 which is arranged perpendicular to a cone axis 14, and a curved surface area 15 which abuts the base surface area 13. The curved surface area 15 is arranged at an angle α to the base surface area 13. The base surface area 13 of the circular cone 8 is arranged on the top surface area 10 of the circular cylinder 7, and the cone axis 14 extends in a direction which is collinear with the cylinder axis 12, such that a cone tip 16 lies in the cylinder axis 12.

According to an embodiment of the present invention, the optical beam-shaping device 2 has a further optical element 17 which is designed as an optical collimating lens, and is integrated into the base surface area 9 of the circular cylinder 7 in the embodiment illustrated in FIG. 1. In this case, “integrated” means the optical collimating lens 17 directly abuts the base surface area 9 of the circular cylinder 7, and that no interface exists between the base surface area 9 and the optical collimating lens 17. A surface which is arranged between two media having different refractive indices is defined as an interface.

The optical collimating lens 17 in the illustrated embodiment is designed as an aspherically curved lens. The optical beam-shaping device 2 with the integrated optical collimating lens 17 may be manufactured as a monolithic entity from one material. Glass and plastic, for example, are suitable as materials for the optical beam-shaping device. In the case of glass, the aspherical curvature is provided by diamond turning, grinding, and polishing, or by pressing a glass blank at high temperature. In the case of plastic, it is produced by injection molding or injection stamping. The surface of the optical collimating lens 17 which faces away from the base surface area 9 of the circular cylinder 7 forms a curved receiving surface 18 for the laser beam 6. In this way, the magnitude of the collimation is effected by the curve radius of the receiving surface 18.

The curved surface area 15 of the recess 8 forms an interface between the optical beam-shaping device 2 and the surrounding environment, and is termed a reflecting surface in the following description. The reflection factor of a reflecting surface depends on the angle of incidence of a laser beam arriving at the surface, as well as on the refractive index of the materials, among other things. So that the incident secondary laser beam is reflected as fully as possible by the curved surface area 15, the angle of incidence θ should fulfill the requirements of total reflection, wherein θ≧arcsin (n₂/n₁). As an alternative, or in addition thereto, the reflected fraction can be increased by coating the reflecting surface with a highly reflective coating. The higher the reflected fraction of the laser beam, the higher the intensity and the higher the visibility of the laser beam at the target object.

The divergent primary laser beam 6 arrives at the curved receiving surface 18, which itself produces a parallel secondary laser beam 19. The secondary laser beam 19 is propagated through the optical beam-shaping device 2 and arrives at the reflecting surface 15 of the conical recess 8. The reflecting surface 15 of the optical beam-shaping device 2 reshapes the secondary laser beam 19 into a flat tertiary laser beam 20 having a linear shape. The tertiary laser beam 20 arrives at the curved surface area 11 of the circular cylinder 7. Said curved surface area is also termed the exiting surface in the following text. The substantial majority of the tertiary laser beam 20 is transmitted through the exit surface 11 and arrives as a reshaped laser beam 21 at an output window 22 which is arranged in the housing 3. The laser beam 23 coupled out of the housing 3 via the output window 22 arrives at a wall, a cover, or another target object, and can be used as a reference marking.

In order that a linear beam which is enclosed over 360° can be coupled out of the housing 3, the output window 22 must be entirely constructed inside the housing 3, as is common in the case of rotary laser systems, for example. In the case of laser systems which are designed as spot and/or linear lasers, the output windows are not typically designed as complete units. The beam spread angle of the outcoupled laser beam is limited by the size of the output window.

Because the visibility of a laser beam at a target object depends on the intensity of the laser beam, among other things, it is a reasonable idea to adjust the beam spread angle of the linear beam in the housing to the characteristics of the output window, in order to exploit the available intensity, and remove the need to shunt a portion of the laser beam. The beam spread angle of the outcoupled linear beam can be adjusted via the area on the reflecting surface which is illuminated by the secondary laser beam. If, for example, the secondary laser beam only illuminates half of the conical reflecting surface, the beam spread angle is limited to 180°.

By displacing the optical axis of the primary laser beam 6 and/or the cylinder axis 12 of the circular cylinder 7, the beam spread angle of the linear beam can be adjusted. For this purpose, an adjustment device 24 is provided, by means of which the position of the beam source 5 can be adjusted in the direction in which the primary laser beam 6 is propagated (the direction of propagation 25) and/or in a plane 26 which is perpendicular to the direction of propagation 25 of the primary laser beam 6. As an alternative, or in addition, a further adjustment device 27 is provided, by means of which the optical beam-shaping device 2 can be adjusted in the direction of propagation 25 of the primary laser beam 6 and/or in a plane 26 which is perpendicular to the direction of propagation 25 of the primary laser beam 6.

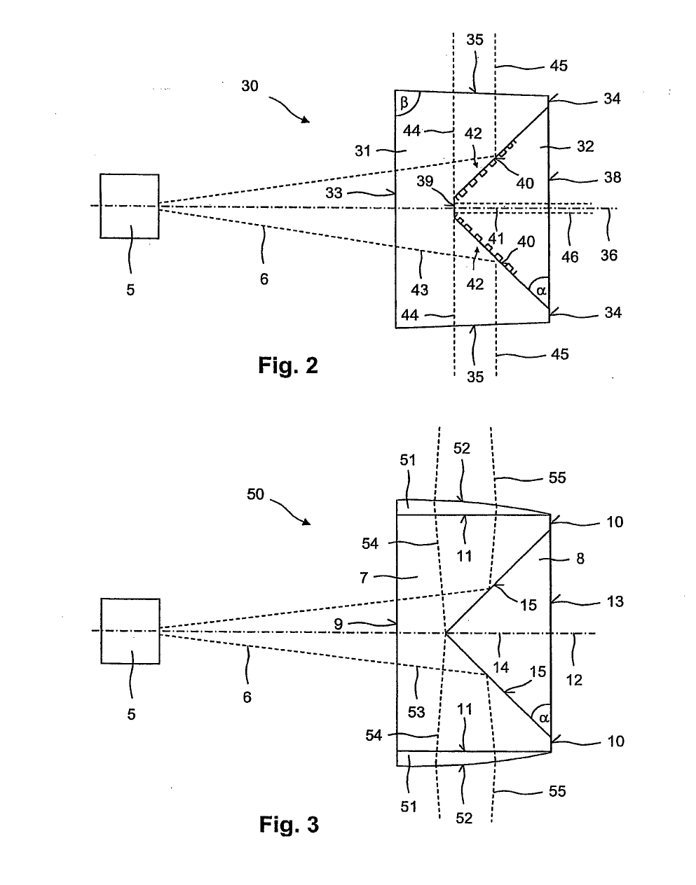

FIG. 2 shows a second embodiment of an optical system 30 according to the invention, which is designed as an optical beam-shaping device. The optical beam-shaping device 30 consists of a base body which is designed in the illustrated embodiment as a right truncated cone 31 and which has a truncated conical recess 32.

A truncated cone is formed when a smaller cone is cut out of a larger right cone in a plane parallel to the base surface area. The larger of the two parallel surface areas is termed the base surface area, and the smaller is termed the top surface area. The distance between the base and the top surface areas defines the height of the truncated cone. The third boundary surface of the truncated cone, said boundary surface connecting the base and the top surface areas, is termed the curved surface area.

The surface of the truncated cone 31 comprises a circular base surface area 33, a circular top surface area 34 which is parallel to the base surface area 33, and a curved surface area 35 which connects the base and top surface areas 33, 34. Said curved surface area 35 is arranged at an angle β to the base surface area 33. The base and the top surface areas 33, 34 are arranged perpendicular to a cone axis 36.

The recess 32, which is also designed in the illustrated embodiment as a truncated cone, has a circular base surface area 38, a circular top surface area 39 which is parallel to the base surface area 38, and a curved surface area 40. Said curved surface area 40 is arranged at an angle α to the base surface area 38. The base and the top surface areas 38, 39 are arranged perpendicular to a cone axis 41. The base surface area 38 of the recess 32 is arranged on the top surface area 34 of the truncated cone 31, and the cone axis 41 of the recess 32 extends collinearly with the cone axis 36 of the truncated conical base body 31.

According to an embodiment of the present invention, the optical beam-shaping device 30 has a further optical element 42 which is designed as an optical collimating lens and which is integrated into the curved surface area 40 of the recess 32. The optical collimating lens 42 is designed as a micro-structured surface structure. Micro-structured surface structures are known by the term “diffractive optical elements,” abbreviated DOE. In principle, they function as an optical grate, and, depending on the angle of incidence, split an incoming laser beam into different diffraction orders. Diffractive optical elements have the advantage that they allow laser beams to be shaped into nearly any desired beam distribution. They are manufactured by means of photolithographic methods as well as by scanning structuring methods such a diamond turning, laser etching, or electron beam lithography.

The base surface area 33 of the truncated conical base body 31 constitutes an interface between the optical beam-shaping device 30 and the surrounding environment, and forms a flat transmission surface designed as a receiving surface for the laser beam. The divergent primary laser beam 6 coming from the beam source 5 arrives at the flat receiving surface 33, at which point the substantial majority of the laser beam is transmitted into the optical beam-shaping device 30 as a divergent secondary laser beam 43. The secondary laser beam 43 arrives at the top surface area 39 and the curved surface area 40 of the recess 32.

The curved surface area 40 of the recess 32 constitutes a further interface between the optical beam-shaping device 30 and the surrounding environment, said interface being designed as a reflecting surface. Because the visibility of a laser beam at a target object depends on the intensity of the laser beam, among other things, the reflected fraction should be as large as possible. The reflected fraction is increased by the incident laser beam fulfilling the condition of total reflection, and/or by coating the curved surface area 40 with a highly reflective coating. The part of the secondary laser beam which strikes the reflecting surface 40 is reshaped into a tertiary laser beam 44 with a linear beam shape. The tertiary laser beam 44 arrives at the curved surface area 35 of the truncated cone 31, which constitutes a further interface between the optical beam-shaping device 30 and the surrounding environment, and which forms a transmission surface which is designed as a flat exit surface for the laser beam. The substantial majority of the tertiary laser beam 44 passes through the flat exit surface 35 as a reshaped laser beam 45.

The top surface area 39 of the recess 32 constitutes a further interface between the optical beam-shaping device 30 and the surrounding environment, said interface being designed as a transmission surface. The fraction of the secondary laser beam 43 which arrives at the top surface area 39 is transmitted through the top surface area 39 and generates a round laser beam which serves as a plumb-line 46. An optical beam-shaping device can be integrated into the transmission surface 39, said optical beam-shaping device shaping the plumb-line beam.

FIG. 3 shows a third embodiment of an optical system 50 according to the invention, designed as an optical beam-shaping device. The optical beam-shaping device 50 is designed in the illustrated embodiment as a base body in the shape of a right circular cone 7 with a circular conical recess 8, similarly to the optical beam-shaping device 2 in FIG. 1. It is different from the latter optical system 2 in that a further optical element 51 is provided, said optical element 51 being designed as an optical focusing lens and directly abutting the curved surface area 10 of the circular cylinder 7. The optical focusing lens 51 and the circular cylinder 7 have a common interface, i.e. no further optical element or any other medium, including air for example, is arranged between the curved surface area 10 of the circular cylinder 7 and the optical focusing lens 51.

The base surface area 9 of the circular cylinder 7 forms a transmission surface for the laser beam, said transmission surface being designed as a flat receiving surface, and the curved surface area 15 of the conical recess 8 forms a flat reflecting surface for the laser beam. The optical focusing lens 51 directly abuts the curved surface area 11 of the circular cylinder 7, wherein said optical focusing lens 51 is an optical lens with an aspherical curvature or a micro-structured surface structure, and forms a transmission surface 52 for the laser beam, said transmission surface being designed as an exit surface and being located on the surface which faces away from the curved surface area 11 of the circular cylinder 7.

The divergent primary laser beam 6 arrives at the flat receiving surface 9 of the optical beam-shaping device 50, at which point the substantial majority of the beam is transmitted into the optical beam-shaping device 50 as a divergent secondary laser beam 53. The secondary laser beam 53 arrives at the reflecting surface 15, at which point the secondary laser beam 53 is reshaped into a tertiary laser beam 54 in the form of a linear beam. The tertiary laser beam 54 is oriented in a direction which is perpendicular to the direction of propagation of the secondary laser beam 53. Finally, the tertiary laser beam 54 arrives at the exit surface 52, and the substantial majority of the tertiary laser beam 54 is transmitted through the exit surface 52 as a reshaped laser beam 55.

The embodiments illustrated in FIGS. 1 to 3 show optical beam-shaping devices 2, 30, 50 having a second optical element 17, 42, 51 which is either arranged at the receiving surface, the reflecting surface, or the exit surface, and is either integrated therein or directly abuts the same. The second optical element can also be arranged on two of the three surfaces—for example on the receiving surface and the reflecting surface, or on the receiving surface and the exit surface, or on the reflecting surface and the exit surface—or on all three surfaces: the receiving surface, the reflecting surface, and the exit surface.

All bounded surfaces for which the directional derivative of the boundary line is continuous are suitable to be the base surface area of the base body. If the directional derivative is not continuous at any point, the direction of the normal and the tangent (left and right) are not the same. This results in an interruption of the 360° linear beam, such that the linear beam is not completely closed.

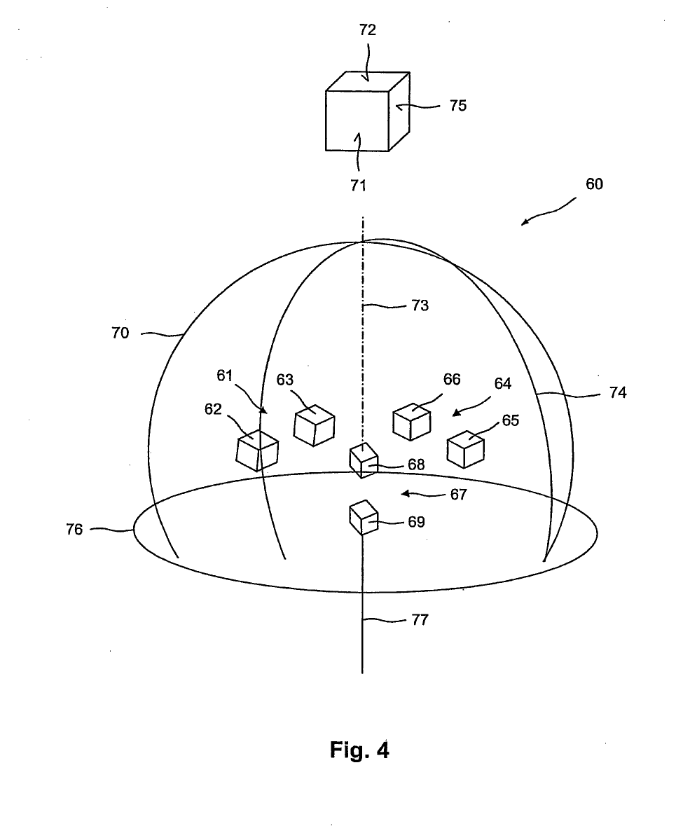

FIG. 4 shows a laser system 60 according to an embodiment of the present invention which generates three linear laser beams, termed linear beams, and one round laser beam with a spot shape, termed the round beam. The laser system 60 has a first beam device 61 with a first beam source 62 and a first optical system 63 according to an embodiment of the present invention, a second beam device 64 with a second beam source 65 and a second optical system 66 according to an embodiment of the present invention, and a third beam device 67 with a third beam source 68 and a third optical system 69 according to an embodiment of the present invention.

The first beam device 61 generates a first linear beam 70 which is arranged in a first vertical plane 71, and which is termed the first vertical linear beam. The first vertical plane 71 is perpendicular to a horizontal plane 72. The orientation of the horizontal plane 72 is defined with reference to a vertical line 73 indicating the action of gravity.

The second beam device 64 generates a second linear beam 74 which is arranged in a vertical direction 75 and is termed the second vertical linear beam. The second vertical plane 75 has an arrangement perpendicular to the horizontal plane 72 and perpendicular to the first vertical plane 71.

The third beam device 67 generates a third linear beam 76 which is arranged in the horizontal direction 72 and is termed the horizontal linear beam. The horizontal linear beam 76 is arranged perpendicular to the first and the second vertical linear beams 70, 74. The third beam device 67 also generates a round beam 77 in addition to the horizontal linear beam 76, which is oriented opposite to the vertical direction 73 and which lies on the intersection line of both vertical linear beams 70, 74. As an alternative, the round beam 77 can also be generated by an additional beam source.

As an alternative to the laser system 60 which has three beam sources 62, 65, 68, the laser system can also have a single beam source. In this case, the laser beam is divided into multiple partial beams by beam splitters. The embodiment of a laser system having a single beam source becomes advantageous if the beam source can provide sufficient power to make the linear beams visible on the substrate. A laser system having a single beam source can be constructed with a more compact design than a laser system in which three beam sources are included.

1. An optical system for shaping a laser beam, having a first optical element which is at least partially designed as a base body having a base surface area and having a curved surface area which abuts the base surface area,
wherein the base surface area and the curved surface area are at least partially designed as transmission surfaces for the laser beam, and the base body has a recess with a curved surface area which is at least partially designed as a reflecting surface for the laser beam.

2. An optical system according to claim 1, further comprising a second optical element that is integrated into the first optical element.

3. An optical system according to claim 2, wherein the second optical element is integrated into at least one of the base surface area of the base body, the curved surface area of the recess, and the curved surface area of the base body.

4. An optical system according to claim 1, further comprising a second optical element that directly abuts the first optical element.

5. An optical system according to claim 4, wherein the second optical element directly abuts at least one of the base surface area of the base body, the curved surface area of the recess, and the curved surface area of the base body.

6. An optical system according to claim 1, wherein the recess has a top surface area which abuts the curved surface area and is designed at least partially as a transmission surface for the laser beam.

7. An optical system according to claim 2, wherein the recess has a top surface area which abuts the curved surface area and is designed at least partially as a transmission surface for the laser beam.

8. An optical system according to claim 3, wherein the recess has a top surface area which abuts the curved surface area and is designed at least partially as a transmission surface for the laser beam.

9. An optical system according to claim 4, wherein the recess has a top surface area which abuts the curved surface area and is designed at least partially as a transmission surface for the laser beam.

10. An optical system according to claim 5, wherein the recess has a top surface area which abuts the curved surface area and is designed at least partially as a transmission surface for the laser beam.

11. An optical system according to claim 6, further comprising an optical element which is integrated into the top surface area or directly abuts the top surface area of the recess.

12. An optical system according to claim 7, further comprising an optical element which is integrated into the top surface area or directly abuts the top surface area of the recess.

13. An optical system according to claim 8, further comprising an optical element which is integrated into the top surface area or directly abuts the top surface area of the recess.

14. An optical system according to claim 9, further comprising an optical element which is integrated into the top surface area or directly abuts the top surface area of the recess.

15. An optical system according to claim 10, further comprising an optical element which is integrated into the top surface area or directly abuts the top surface area of the recess.

16. A laser system having a beam source for generating a laser beam, and having an optical system for shaping the laser beam, the optical system having a first optical element which is at least partially designed as a base body having a base surface area and having a curved surface area which abuts the base surface area,
wherein the base surface area and the curved surface area are at least partially designed as transmission surfaces for the laser beam, and the base body has a recess with a curved surface area which is at least partially designed as a reflecting surface for the laser beam.

17. A laser system according to claim 16, further comprising an adjustment device, by means of which at least one of the position of the beam source with respect to the optical system and the position of the optical system with respect to the beam source can be adjusted in at least one of a direction of propagation of the laser beam and in a plane which is perpendicular to the direction of propagation of the laser beam.

18. A laser system according to claim 16, comprising a first optical system which generates a first flat laser beam with a linear shape, and a second optical system which generates a second flat laser beam with a linear shape.

19. A laser system according to claim 17, comprising a first optical system which generates a first flat laser beam with a linear shape, and a second optical system which generates a second flat laser beam with a linear shape.

20. A laser system according to claim 18, comprising a third optical system which generates a third flat laser beam with a linear shape.

21. A laser system according to claim 19, comprising a third optical system which generates a third flat laser beam with a linear shape.

22. A laser system according to claim 16, comprising at least one optical system that generates a round laser beam in addition to a linear laser beam.

23. A laser system according to claim 17, comprising at least one optical system that generates a round laser beam in addition to a linear laser beam.

24. A laser system according to claim 18, comprising at least one optical system that generates a round laser beam in addition to a linear laser beam.

25. A laser system according to claim 19, comprising at least one optical system that generates a round laser beam in addition to a linear laser beam.

26. A laser system according to claim 20, comprising at least one optical system that generates a round laser beam in addition to a linear laser beam.

27. A laser system according to claim 21, comprising at least one optical system that generates a round laser beam in addition to a linear laser beam.
